(19) United States
(12) Patent Application Publication
(10) Pub. No.: US 2025/0311007 A1
(43) Pub. Date: Oct. 2, 2025

(54) PRACH POWER CONTROL IN SUB-BAND FULL-DUPLEX (IBFD) NETWORKS

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US); Wanshi CHEN, San Diego, CA (US)

(21) Appl. No.: 18/621,925

(22) Filed: Mar. 29, 2024

(51) Int. Cl. H04W 74/0833; H04L 5/14; H04W 52/36; H04W 74/08

(52) U.S. Cl. CPC H04W 74/0833; H04L 5/14; H04W 52/36; H04W 74/0866

(57) ABSTRACT

Aspects relate to mechanisms for providing power control for sub-band full-duplex (SBFD) random access channel (RACH) preamble message transmissions. A user equipment (UE) can transit a first random access preamble message at a first transmit power in a first slot and a second random access preamble message (e.g., a retransmission) at a second transmit power in a second slot. The second transmit power can be adapted corresponding to a respective slot type of each of the first slot and the second slot.

### TECHNICAL FIELD

The technology discussed below relates generally to wireless communication systems, and more particularly, to power control of physical random access channel (PRACH) messages.

### INTRODUCTION

Wireless communication systems, such as those specified under fifth generation (5G) systems, referred to as New Radio (NR) systems, sixth generation (6G) systems, and other future generation systems, may be widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). In a communication network, in order for a user equipment (UE) to gain access to a cell either initially or after link failure, the UE may perform a random access procedure over a physical random access channel (PRACH). to acquire uplink synchronization and obtain specified network identification for obtaining radio access communication with the network.

A UE and a network entity may further exchange signals using various duplex modes. Duplex modes include, for example, half-duplex and full-duplex. In half duplex communication, only one node (e.g., UE or network entity) transmits at a time. In full-duplex communication, each node (e.g., UE and network entity) can transmit at the same time. An example of half-duplex communication is time division duplex (TDD) communication. For example, in TDD, uplink signaling (e.g., from a UE to a network entity) and downlink signaling (e.g., form the network entity to the UE) are separately scheduled in time within the same TDD carrier bandwidth. Thus, TDD uplink and downlink communications may be transmitted on the same frequencies (e.g., on the same carrier). An example of full-duplex communication is frequency division duplex (FDD) communication. For example, in FDD, uplink signaling and downlink signaling are simultaneously scheduled in time. However, uplink and downlink may be transmitted at different frequencies (e.g., on different and spaced apart FDD carriers). Another example of a full-duplex mode is sub-band full-duplex (SBFD) communication. For example, in SBFD, the TDD carrier bandwidth is divided into sub-bands, with each sub-band allocated for either uplink signaling or downlink signaling. An example of SBFD communication includes in-band full-duplex (IBFD), in which the downlink and uplink sub-bands overlap in both the time and frequency domains.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for wireless communication at a user equipment (UE) includes one or more memories and one or more processors coupled to the one or more memories. The one or more processors can be configured to transmit a first random access preamble message at a first transmit power in a first slot and transmit a second random access preamble message at a second transmit power in a second slot. The second transmit power is adapted corresponding to a respective slot type of each of the first slot and the second slot. The respective slot type includes a half-duplex slot type or a sub-band full-duplex (SBFD) slot type.

Another example provides a method operable at a user equipment (UE). The method incudes transmitting a first random access preamble message at a first transmit power in a first slot and transmitting a second random access preamble message at a second transmit power in a second slot. The second transmit power is adapted corresponding to a respective slot type of each of the first slot and the second slot. The respective slot type includes a half-duplex slot type or a sub-band full-duplex (SBFD) slot type.

Another example provides a user equipment (UE) including means for transmitting a first random access preamble message at a first transmit power in a first slot and means for transmitting a second random access preamble message at a second transmit power in a second slot. The second transmit power is adapted corresponding to a respective slot type of each of the first slot and the second slot. The respective slot type includes a half-duplex slot type or a sub-band full-duplex (SBFD) slot type.

Another example provides a non-transitory computer-readable medium having stored therein instructions executable by one or more processors of a user equipment (UE) to transmit a first random access preamble message at a first transmit power in a first slot and transmit a second random access preamble message at a second transmit power in a second slot. The second transmit power is adapted corresponding to a respective slot type of each of the first slot and the second slot. The respective slot type includes a half-duplex slot type or a sub-band full-duplex (SBFD) slot type.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram providing a high-level illustration of one example of a configuration of a disaggregated base station according to some aspects.

FIGS. 4A-4C illustrate examples of full-duplex communication in unpaired spectrum according to some aspects.

FIG. 5A is a schematic diagram of a network entity configured for full-duplex communication according to some aspects.

FIG. 5B is schematic illustration of an example of sub-band full-duplex (SBFD) wireless communication according to some aspects.

FIG. 6 is a diagram illustrating an example of a random access procedure according to some aspects.

FIG. 7 is a diagram illustrating another example of a random access procedure according to some aspects.

FIG. 8 is a diagram illustrating an example of random access (RACH) occasions (ROs) across slots according to some aspects.

FIG. 9 is a diagram illustrating an example of power control for RACH preamble retransmissions based on slot types according to some aspects.

FIG. 10 is a diagram illustrating another example of power control for RACH preamble retransmissions based on slot type according to some aspects.

FIG. 11 is a diagram illustrating another example of power control for RACH preamble retransmissions based on slot type according to some aspects.

FIG. 12 is a diagram illustrating another example of power control for RACH preamble retransmissions based on slot type according to some aspects.

FIG. 13 is a diagram illustrating an example of RACH preamble retransmissions based on slot type power states according to some aspects.

FIG. 14 is a diagram illustrating another example of power control for RACH preamble retransmissions based on slot type according to some aspects.

FIG. 15 is a block diagram illustrating an example of a hardware implementation for a user equipment (UE) employing a processing system according to some aspects.

FIG. 16 is a flow chart illustrating an exemplary process for PRACH power control in SBFD networks according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

To gain initial access to a cell, a UE may perform a random access procedure over a physical random access channel (PRACH). The random access procedure involves a UE randomly selecting a preamble from an available set of preambles within a cell served by a network entity, and transmitting the selected preamble to the network entity in a RACH preamble message, referred to as msg1 or msgA. Random access (RACH) occasions (ROs) may be defined in time and frequency for a UE to send the preamble message to the network entity. If the UE does not receive a response from the network entity, the UE may determine that the RACH procedure failed and select a new RACH preamble and new RO to retransmit the preamble message to the network entity. For each transmission occasion (e.g., initial transmission and retransmission(s)) of a preamble message transmission (e.g., PRACH msg1 or msgA transmission), the UE determines the transmission power of the preamble message. For example, for each preamble retransmission (e.g., after a RACH fail), the UE may step-wise increase the transmission power by a power ramping step to improve the likelihood of a RACH success.

In sub-band full-duplex (SBFD) networks, the ROs may occur within half-duplex (HD) slots (e.g., uplink (UL) slots) or in SBFD slots. However, cross link interference (CLI) may occur between uplink transmissions and downlink transmissions occurring within the sub-bands of the same carrier in the same SBFD slot. As a result, each time a SBFD-aware UE increases the transmission power of the preamble message, the CLI with respect to any downlink transmissions to other UEs within the same SBFD slot may increase. In addition, the uplink quality (e.g. in terms of SINR) for PRACH reception at the gNB in SBFD symbols is worse than TDD symbols due to the existence of self-interference and/or other inter-cell interference. The gNB may configure the UE with different power control parameters for PRACH transmission in SBFD-RO that PRACH transmission in TDD-RO.

Various aspects are related to mechanisms for providing power control for SBFD preamble message transmissions. In some examples, separate power ramping steps can be defined for transitions between half-duplex (HD) slots and SBFD slots. For example, a first power ramping step may be defined when the last preamble message transmission is in a SBFD slot and the new retransmission is in an HD slot. In addition, a second power ramping step may be defined when the last preamble message transmission is in a HD slot and the new retransmission is in a SBFD slot.

In other examples, the UE may increment the transmission power with a power ramping step that corresponds to the slot type of the RO of the new preamble message retransmission. In other examples, the UE may reset the transmission power each time the slot type of the RO for the retransmission of the preamble message changes. In other examples, the UE may maintain two separate power states for both SBFD and HD slot types, and the UE may transmit the retransmission of the preamble message with the power of the state that matches the slot type for the retransmission. In other examples, the UE may add an offset to transmissions and/or retransmissions of preamble messages in SBFD slots.

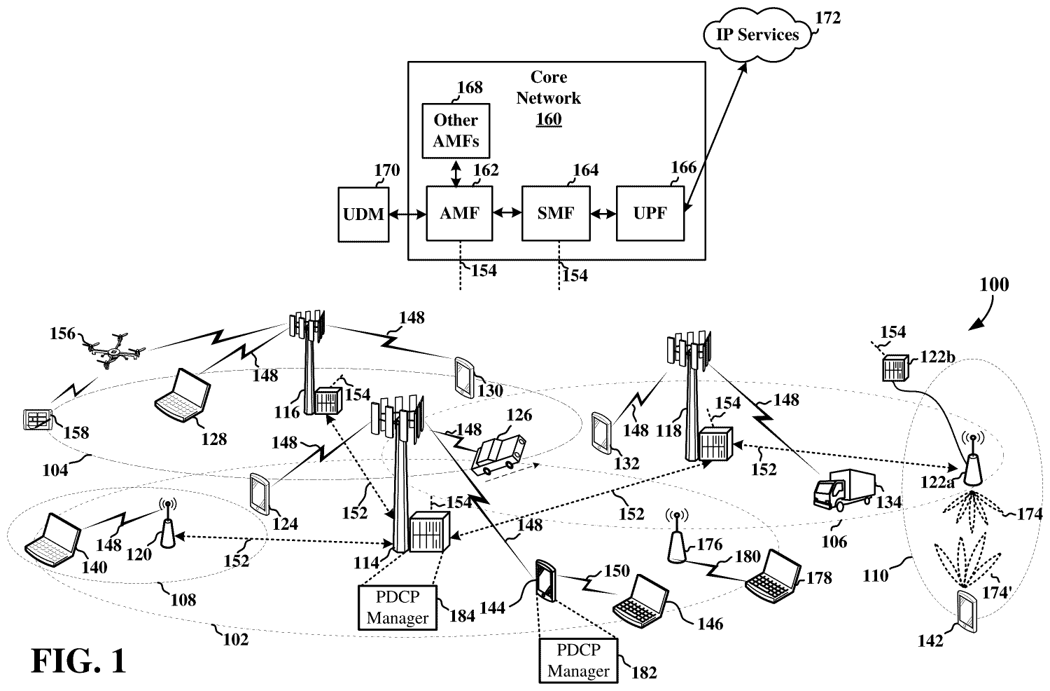

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of ims. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

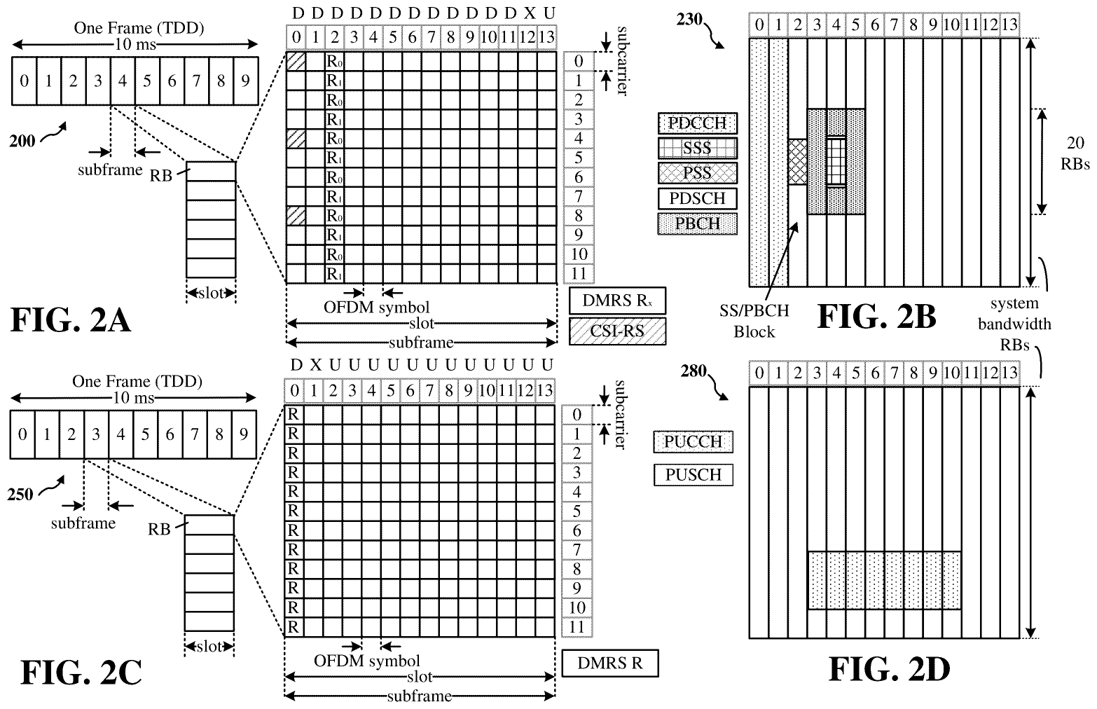

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

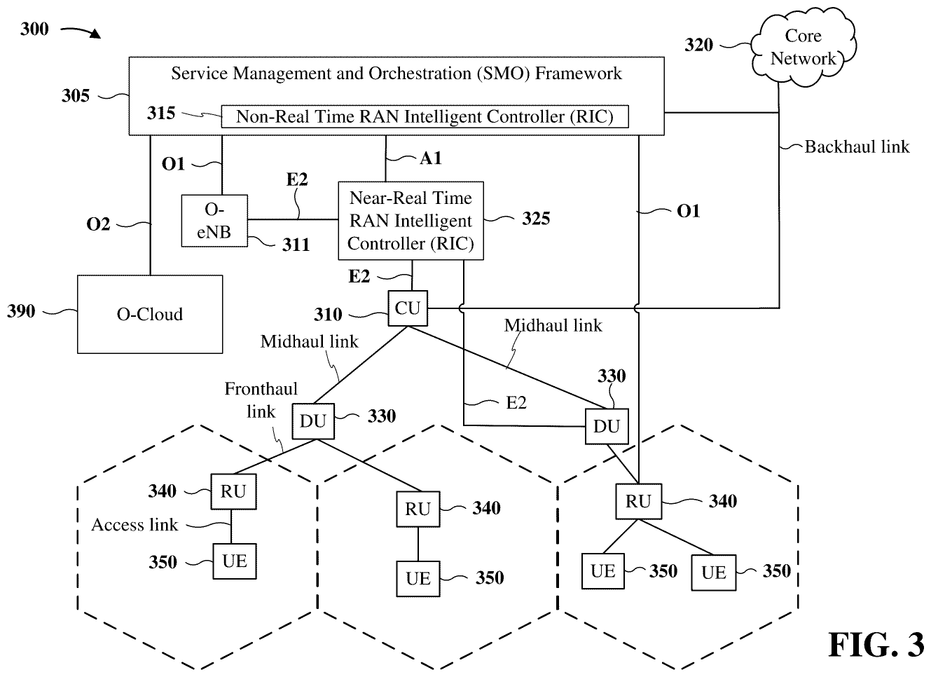

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E3 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O3 interface). Such virtualized network elements can include, but are not limited to, CUs 310, DUs 330, RUs 340 and Near-RT RICs 325. In some implementations, the SMO Framework 305 can communicate with a hardware aspect of a 5G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E3 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

A transport block may be communicated between a network entity (e.g., an aggregated or disaggregated base station) and a UE over downlink resources or uplink resources allocated in a slot for the transport block. When operating in a full-duplex mode, both downlink and uplink resources may be allocated within symbols of the same slot for the transmission of both a downlink transport block and an uplink transport block, respectively. In some examples, the downlink and uplink resources may overlap in time (e.g., one or more symbols of the slot may carry both the downlink transport block and the uplink transport block). For example, simultaneous transmissions in different directions (uplink and downlink) may utilize frequency division duplex (FDD) in paired spectrum (e.g., the transmissions in different directions are carried on different carrier frequencies) or in unpaired spectrum (e.g., the transmissions in different directions are carried on a single carrier bandwidth).

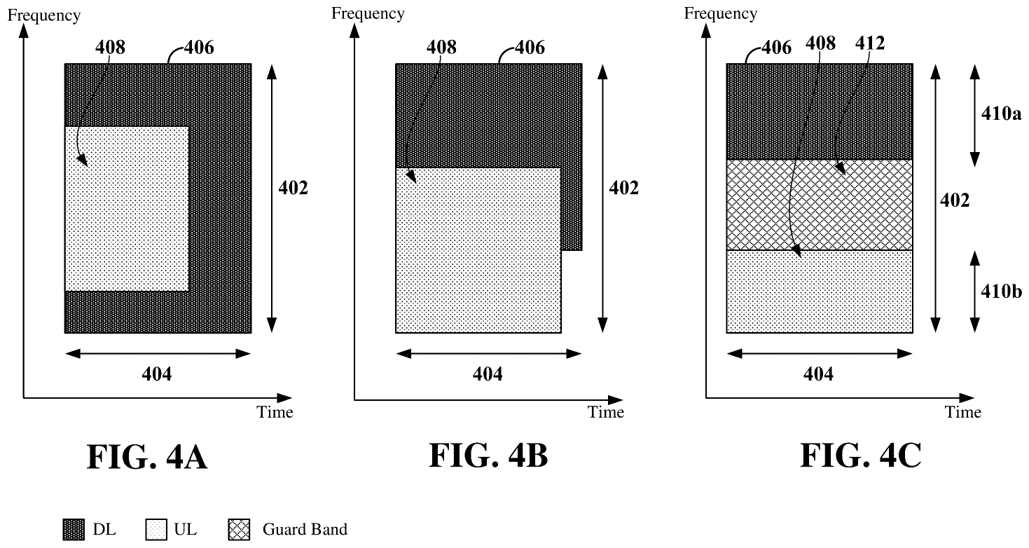

FIGS. 4A-4C illustrate examples of full-duplex communication in unpaired spectrum according to some aspects. In the examples shown in FIGS. 4A-4C, time is in the horizontal direction and frequency is in the vertical direction. Here, a carrier bandwidth 402 (or set of one or more active bandwidth parts (BWPs)) is illustrated along the frequency axis and a slot 404 is illustrated along the time axis.

FIGS. 4A and 4B illustrate in-band full-duplex (IBFD) communication, while FIG. 4C illustrates sub-band full-duplex (SBFD) communication. For IBFD communication, as shown in FIGS. 4A and 4B, downlink and uplink transmissions occur on the same time and frequency resources. For example, downlink resources 406 allocated for transmissions in the downlink direction overlap in both time and frequency with uplink resources 408 allocated for transmissions in the uplink direction. The overlap may be full (as shown in FIG. 4A) or partial (as shown in FIG. 4B).

For SBFD communication, as shown in FIG. 4C, the carrier bandwidth 402 (or active BWPs) may be divided into sub-bands 410a and 410b. Each sub-band 410a and 410b may be allocated for communication in a single direction. For example, sub-band 410a may be allocated for downlink transmissions, while sub-band 410b may be allocated for uplink transmissions. Thus, downlink resources 406 allocated for transmissions in the downlink direction overlap in time, but not in frequency, with uplink resources 408 allocated for transmissions in the uplink direction. The downlink resources 406 may further be separated from the uplink resources 408 in the frequency domain by a guard band 412 to isolate the uplink and downlink transmissions in frequency.

As used herein, IBFD communication may be considered a type of SBFD communication in which the downlink and uplink sub-bands overlap in both the time and frequency domains.

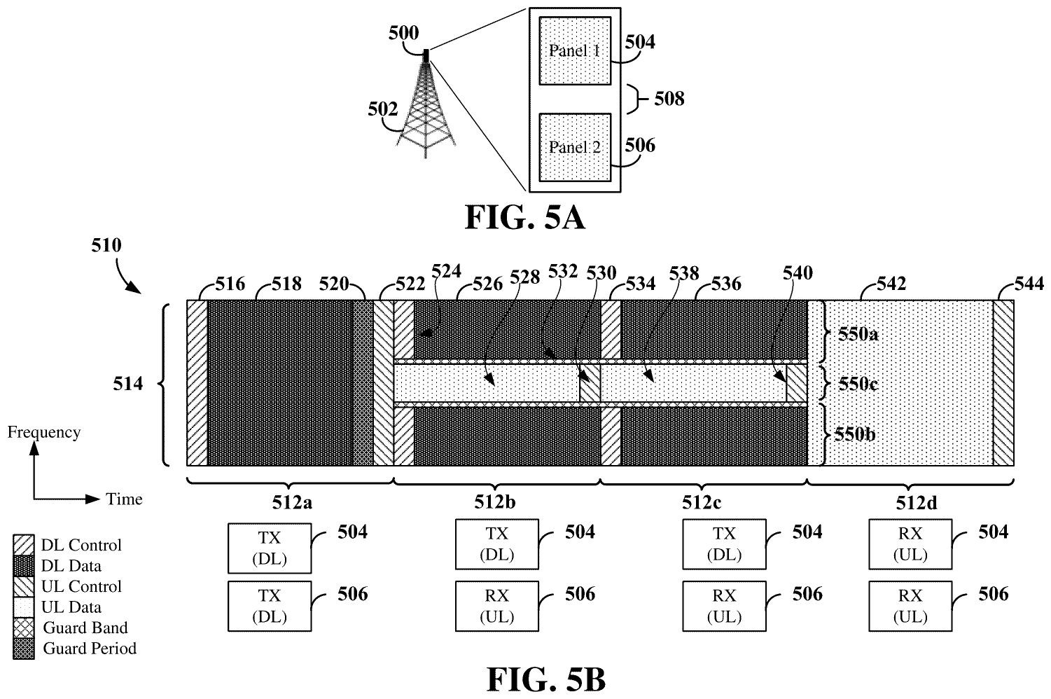

FIG. 5A is a schematic diagram of a network entity 502 (e.g., aggregated or disaggregated base station) including an antenna array 500 configured for full-duplex communication according to some aspects. The antenna array 500 is divided into two panels (panel 1 504, panel 2 506) with a physical separation 508 therebetween. Each of the two panels may include, for example, a subarray of antennas. A given panel may transmit and/or receive a beam or a beam group. In one example, the panels may be physically separated from one another by a distance selected to provide improved isolation between simultaneous transmission (Tx) and reception (Rx) operations in full-duplex mode, thereby mitigating at least a portion of self-interference resulting from signals being simultaneously transmitted/received. The multi-panel antenna configuration shown in FIG. 5A may also be applicable to UEs to enable full-duplex communication at the UE.

FIG. 5B is schematic illustration of an example of sub-band full-duplex (SBFD) wireless communication 510 using the multi-panel antenna array 500 shown in FIG. 5A according to some aspects. In the example shown in FIG. 5B, time is in the horizontal direction with units of slots 512a-512d, each including a plurality of OFDM symbols; and frequency is in the vertical direction. Here, a carrier bandwidth 514 (or set of one or more active BWPs) is illustrated along the frequency axis. The carrier bandwidth 514 (or active BWPs) may be divided into a number of sub-bands 550a-550c for SBFD operation.

In the example shown in FIG. 5B, in slot 512a, the antenna array 500 is first configured for downlink (DL) communication (e.g., DL burst 516 and DL data portion 518). The DL burst 516 may include DL control transmitted within the first few symbols of the slot 512a. The DL control 516 may include, for example, a physical downlink control channel (PDCCH) carrying DCI that may be related to the slot 512a or a previous or subsequent slot. In an example, the DCI may include common DCI or UE-specific DCI. The common DCI may include, for example, common control information broadcast to a group of UEs or all UEs in the cell. The UE-specific DCI may include, for example, HARQ feedback information (e.g., ACK/NACK), scheduling information for scheduling a downlink data transmission and/or uplink transmission in the slot 512a or a subsequent slot (e.g., slot 512b, 512c, and/or 512d), and other suitable information. The DL burst 516 may further include various DL reference signals (e.g., SSB and/or CSI-RS). In this example, both panel 1 504 and panel 2 506 may be configured for DL transmission. The DL data portion 518 may include DL data carried within, for example, a PDSCH. In addition to the DL data, the DL data portion 518 may further include DL reference signals (e.g., DMRS) for use in demodulating and decoding the DL data.

Slot 512a may also include a common uplink (UL) burst 522 at the end of slot 512a. The common UL burst 522 may include, for example, a PUCCH carrying UCI and other UL signals. As illustrated in FIG. 5B, the end of the DL data portion 518 may be separated in time from the beginning of the UL burst 522. This time separation 520 may sometimes be referred to as a gap, a guard period, a guard interval, and/or various other suitable terms. This separation may provide time for the network entity and UE to perform a switch-over between transmitting and receiving, or vice-versa. In this example, both panel 1 504 and panel 2 506 may be configured for UL transmission during the UL burst 522.

In slots 512b and 512c, the antenna array 500 is configured for both DL communication and UL communication. For example, in slots 512b and 512c, the carrier bandwidth 514 (or active BWPs) is shown partitioned between uplink transmissions and downlink transmissions. Sub-bands 550a and 550b are allocated for downlink transmissions, while sub-band 550c is allocated for uplink transmissions. In an example operation of the SBFD configuration shown in FIG. 5, panel 1 504 may be configured for DL transmission at both edges (e.g., sub-bands 550a and 550b) of the carrier bandwidth 514 (or active BWPs) and panel 2 506 may be configured for UL reception in the middle (e.g., sub-band 550c) of the carrier bandwidth 514 (or active BWPs).

In each of the SBFD slots 512b and 512c, the DL sub-bands 550a and 550b include a DL burst 524 and 534, respectively, which may include a PDCCH carrying DCI and/or DL reference signals, in the initial portion of the slots 512b and 512c. Following the DL bursts 524 and 534, slots 512b and 512c each include a DL data portion 526 and 536, respectively, for transmitting DL data within sub-bands 550a and 550b. For example, the DL data may be transmitted within a PDSCH. In addition to the DL data, the DL data portions 526 and 536 may further include DL reference signals (e.g., DMRS) for use in demodulating and decoding the DL data.

In the uplink (UL) sub-band 550c, the slots 512b and 512c each include an UL data portion 528 and 538, respectively, for transmitting UL data. For example, the UL data may be transmitted within a PUSCH. Following the UL data portions 528 and 538, the UL sub-band 550c of slots 512b and 512c each include an UL burst 530 and 540, respectively. The UL burst 530 and 540 may include, for example, a PUCCH including UCI and/or other UL signals. Guard bands 532 are further provided between the UL sub-band 550c and the DL sub-bands 550a and 550b to mitigate self-interference between simultaneous DL transmissions in the DL sub-bands 550a and 550b and UL transmissions in the UL sub-band 550c.

Slots 512b and 512c are SBFD slots utilizing FDM for multiplexing uplink and downlink transmissions in frequency. The SBFD slot configurations shown in FIG. 5 are merely exemplary, and other configurations of SBFD slots may be utilized in various aspects of the disclosure. For example, SBFD slots including other configurations of UL and DL sub-bands (e.g., the configuration shown in FIG. 4C or other suitable sub-band configurations) may be employed in various aspects.

In slot 512d, the antenna array 500 is configured for UL communication. For example, slot 512d includes an UL data portion 542 followed by an UL burst 544. The UL data portion 542 and UL burst 544 may include UL control information and/or UL data, as discussed above. In this example, both panel 1 504 and panel 2 506 may be configured for UL reception. Slots 512a and 512d are half-duplex TDD slots utilizing TDM for multiplexing DL transmissions and UL transmissions in time.

In order to gain access to a cell, a UE may perform a random access procedure over a physical random access channel (PRACH). The UE may identify a random access search space including PRACH resources for initiating a RACH procedure from the SIB 1. For example, a random access process may be commenced after a UE acquires a cell and determines occurrence of a RACH occasion (e.g., PRACH resources) after reading SSB and a SIB 1. The SSB provides the initial system information (SI), and the SIB1 (and other SIB blocks) provide the remaining minimum SI (RMSI). For example, the PBCH MIB of the SSB may carry a first part of the SI that a user equipment (UE) needs in order to access a network. The SIBs (e.g., SIB1 and SIB2) can carry the RMSI that a UE needs to gain access to the network.

RACH procedures may be performed in various scenarios, such as loss of uplink synchronization, lack of available PUCCH resources, scheduling request failure, and other use cases. In addition, a RACH procedure may be contention-based or contention-free and may include a 2-step RACH process (contention-based or contention-free), a 3-step RACH process (contention-free), or a 4-step RACH process (contention-based).

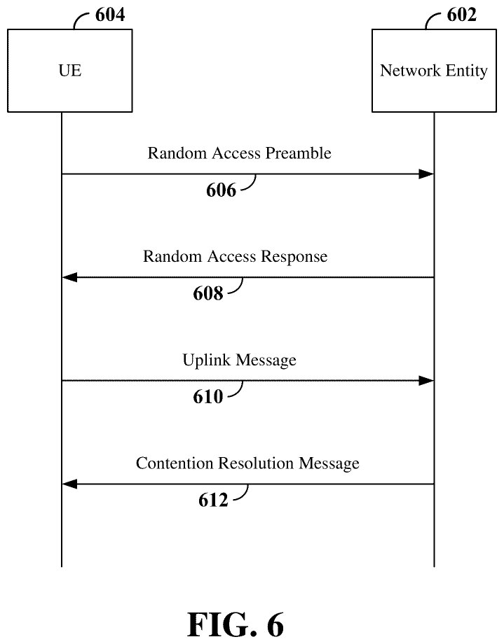

FIG. 6 is a diagram illustrating an example of a 4-step contention-based random access (CBRA) procedure 600 between a network entity 602 and a UE 604 according to some aspects. The network entity 602 may correspond, for example, to any of the network entities shown in FIGS. 1 and/or 3. In addition, the UE 604 may correspond, for example, to any of the UEs shown in FIGS. 1 and/or 3.

The random access procedure 400 shown in FIG. 4 is initiated by the UE 604 randomly selecting a preamble from an available set of preambles within the cell served by the network entity 602, and transmitting the selected preamble to the network entity 602 in a RACH preamble message 606 (msg1). In an example, the UE 604 may select from 64 possible preamble sequences for inclusion in the RACH preamble message 606. The msg1 606 may be transmitted by the UE 604 over a selected PRACH resource with power ramping. The selected PRACH resource may include supplementary uplink resources or normal uplink resources. Here, supplementary uplink resources include lower frequency resources than normal uplink resources. Thus, supplementary uplink resources and uplink resources each correspond to a different respective uplink frequency band. The msg1 606 may further be communicated on a beam selected by the UE 604 based on beam measurements (e.g., RSRP/RSRQ/SINR) performed by the UE 604. The beam may correspond, for example, to an SSB beam.

If the preamble is successfully detected by the network entity 602, the network entity 602 transmits a random access response (RAR) message 608 (msg2) including a PDCCH and PDSCH to the UE 604. If no msg2 (RAR) 608 is received within a RAR window, the UE 604 may retransmit msg1 606 with power boost. The msg2 608 (PDCCH+PDSCH) includes an identifier of the preamble sent by the UE 604, a Timing Advance (TA), a temporary cell radio network temporary identifier (TC-RNTI) or random access (RA) RNTI for the UE 604 and a grant of assigned uplink (UL) resources. The PDCCH in msg2 608 may be scrambled with the RA-RNTI, which is a function of a RACH occasion (RO) (e.g., time-frequency resources allocated for RACH msg1) that the UE 604 used to send msg1 606. A medium access control-control element (MAC-CE) within the PDSCH provides an acknowledgement of the reception of msg1 and the UL grant. To receive msg2 608, the UE 604 may monitor DCI 1_0 for the PDCCH scrambled with the RA-RNTI corresponding to the RO used by the UE 604 to transmit msg1 606, and if detected, proceeds with PDSCH decoding. Upon receipt of the RAR message 608, the UE 604 compares the preamble ID to the preamble sent by the scheduled entity in the RACH preamble message 606. If the preamble ID matches the preamble sent in the RACH preamble message 606, the UE 604 applies the timing advance and starts a contention resolution procedure.

Since the preamble is selected randomly by the scheduled entity, if another scheduled entity selects the same preamble in the same RO, a collision may result between the two scheduled entities. Any collisions may then be resolved using the contention resolution procedure. During contention resolution, the UE 604 transmits an uplink message (msg3) 610 on the common control channel (CCCH) using the TA and assigned uplink resources in the PDSCH of msg2 608. In an example, the uplink message 610 is a Layer 2/Layer 3 (L2/L3) message, such as a Radio Resource Control (RRC) Connection Request message. The uplink message 610 includes an identifier of the UE 604 (UE-ID) for use by the scheduling entity in resolving any collisions. Although other scheduled entities may transmit colliding uplink messages utilizing the TA and assigned uplink resources, these colliding uplink messages will likely not be successfully decoded at the scheduling entity since the colliding uplink messages were transmitted with TAs that were not intended for those scheduled entities.

Upon successfully decoding the uplink message, the network entity 602 transmits a contention resolution message 612 to the UE 604 (msg4). The contention resolution message 612 may be, for example, an RRC-Connection Setup message. In addition, the contention resolution message 612 includes the identifier of the UE 604 that was received in the uplink message 610. The UE 604, upon receiving its own identity back in the contention resolution message 612, concludes that the random access procedure was successful and completes the RRC connection setup process. Any other scheduled entity receiving the RRC-Connection Setup message with the identity of the UE 604 will conclude that the random access procedure failed and re-initialize the random access procedure.

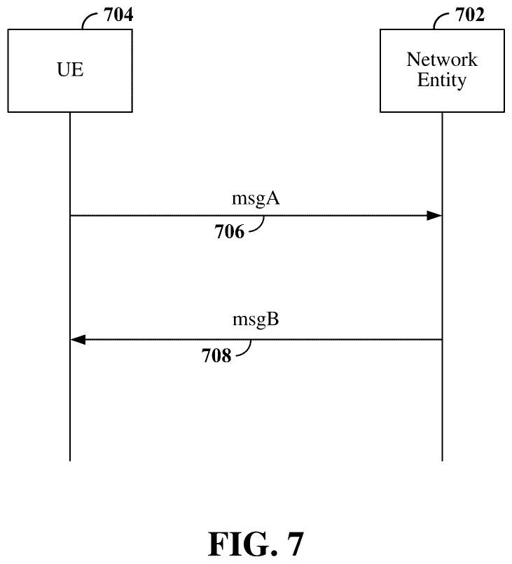

The four-step CBRA procedure 600 can be compressed into the two-step random-access procedure 700 illustrated in FIG. 7. The two-step random-access procedure 700 reduces overhead and latency associated with control signaling by removing a transmission in each direction between the UE 704 and network entity 702. In comparison to FIG. 6, the two-step random-access procedure 700 commences with a transmission by the UE 704 of a single message (msgA 706) that includes the RACH preamble message 606 and uplink message 610 sent of the contention-based random-access procedure 600. Here, the uplink message 610 may be a scheduled PUSCH transmission sent over a PUSCH resource and the RACH preamble message 606 may be sent over a selected PRACH resource. The network entity 702 responds with a single message (msgB 708) that includes the random access response 608 and the contention resolution message 612.

For each of the 4-step and 2-step RACH procedures shown in FIGS. 6 and 7, the initial RACH preamble message may be sent by the UE within a random access (RACH) occasion (RO). A RO is a specific time-frequency domain resource that is available for reception of the RACH preamble message (e.g., msg1 or msgA). ROs may be configured within a subset of slots (e.g., RACH slots) that can repeat every RACH configuration period within a cell. For example, the RACH periodicity may be set between 10 and 160 ms, which indicates how often ROs occur in a cell. Within a RACH slot, there can be a number of ROs.

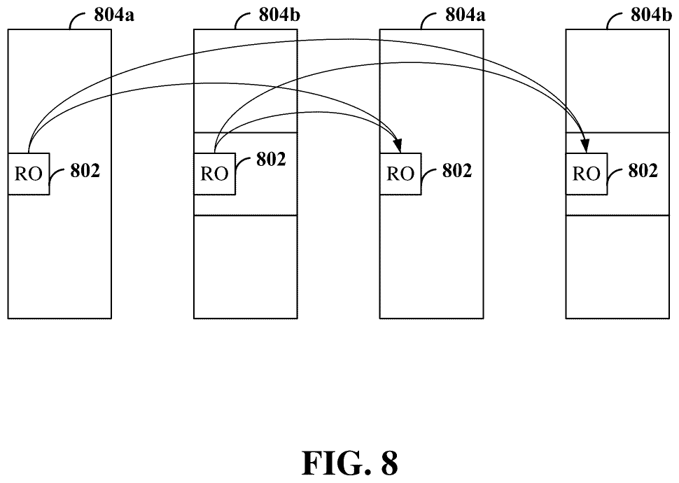

FIG. 8 is a diagram illustrating an example of random access (RACH) occasions (ROs) across slots according to some aspects. In the example shown in FIG. 8, ROs 802 are configured across a plurality of RACH slots 804a and 804b. The RACH slots 804a and 804b include both half-duplex (HD) uplink (UL) slots 804a (e.g., UL symbols of a slot) and SBFD slots 804b (e.g., SBFD symbols of a slot). Within the SBFD slots 804b, the ROs 802 are configured within the UL sub-band 806 of the SBFD slot 804b.

The RACH configuration for SBFD-aware UEs may include, for example, a single RACH configuration in which the ROs 802 are configured within both UL slots 804a and SBFD slots 804b and the ROs 802 within the SBFD slots are valid for SBFD-aware UEs. In other examples, two separate RACH configurations may be provided. A first RACH configuration may be a legacy RACH configuration in which ROs 802 are configured only in UL slots 804a (e.g., UL symbols of a slot). A second RACH configuration may be a SBFD RACH configuration in which ROs 802 may be configured in both UL slots 804a and SBFD slots 804b (e.g., SBFD symbols of a slot). A SBFD-aware UE may utilize either the first RACH configuration or the second RACH configuration to select a RO 802 for transmission of the preamble message.

In an example, for SBFD-aware UEs, the UE may select a RO 802 within any of the slots 804a and 804b to transmit a preamble message (e.g., msg1 or msgA). For example, the UE may select a RO 802 within an UL slot 804a for transmission of msg1. The UE may then initialize a monitoring window to monitor for reception of msg2 or msgB. If the UE does not receive msg2 or msgB within the monitoring window, the UE may determine that the RACH procedure failed and select a new RACH preamble and new RO 802 to start the random access procedure over again by retransmitting a preamble message. For example, the UE may select a RO 802 within another UL slot 804a or within a SBFD slot 804b for the retransmission of msg1 or msgA.

For each transmission occasion (e.g., initial transmission and retransmission(s)) of a preamble message transmission (e.g., PRACH msg1 or msgA transmission), the UE determines the transmission power on an active bandwidth part (BWP) b of carrier f serving cell C based on a downlink reference signal (DL RS) for the serving cell C in transmission occasion i as follows:

$${P}_{PRACH , b , f , c} ( i ) = min \{ {P}_{CMAX , f , c} ( i ) , {P}_{PRACH , target , f , c} + {PL}_{b , f , c} \} \qquad ( Equation 1 )$$

in dBm, where P_{CMAX,f,c}(i) is the UE configured maximum output power defined for carrier f of serving cell C within transmission occasion i, P_{PRACH,target,f,c} is the PRACH target reception power PREAMBLE_RECEIVED_TARGET_POWER provided by higher layers (e.g., SIB1) for the active UL BWP b of carrier f of serving cell C, and PI_{b,f,c} is a pathloss for the active UL BWP b of carrier f. The PRACH target reception power PREAMBLE_RECEIVED_TARGET_POWER may be set to:

$$preambleReceivedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA . \qquad ( Equation 2 )$$

If the preamble message transmission is the first transmission, the value of (PREAMBLE_POWER_RAMPING_COUNTER−1)×PREAMBLE_POWER_RAMPING_STEP+POWER_OFFSET_2STEP_RA is equal to zero (e.g., the PREAMBLE_POWER_RAMPING_COUNTER is set to one as this is the first preamble transmission). For each subsequent preamble retransmission (e.g., after a RACH fail), the counter (e.g., PREAMBLE_POWER_RAMPING_COUNTER) is incremented and the transmission power is step-wise increased by the power ramping step (e.g., PREAMBLE_POWER_RAMPING_STEP+POWER_OFFSET_2STEP_RA). In this manner, the transmission power of the preamble message is increased with each RACH attempt to improve the likelihood of a RACH success (e.g., reception of msg2 or msgB).

However, for SBFD slots, cross link interference (CLI) may occur between uplink transmissions (e.g., RACH msg1/msgA transmissions) and downlink transmissions. As a result, each time the SBFD-aware UE increases the transmission power of the preamble message, the possibility of interference with a downlink transmission to another UE may further increase.

Therefore, various aspects are directed to mechanisms for providing power control for SBFD preamble message transmissions. It should be understood that a type of SBFD communication is an IBFD communication in which the downlink and uplink sub-bands overlap in both the time and frequency domains. As such, the description herein applies equally to SBFD communication in which the downlink and uplink sub-bands are separated in frequency and IBFD communication in which the downlink and uplink sub-bands overlap in frequency.

In some examples, separate power ramping steps can be defined for transitions between half-duplex (HD) slots and SBFD slots. For example, a first power ramping step may be defined when the last preamble message transmission is in a SBFD slot and the new retransmission is in an HD slot. In addition, a second power ramping step may be defined when the last preamble message transmission is in a HD slot and the new retransmission is in a SBFD slot.

In other examples, the UE may increment the transmission power with a power ramping step that corresponds to the slot type of the RO of the new preamble message retransmission. In other examples, the UE may reset the transmission power (e.g., to preambleReceivedTargetPower+DELTA_PREAMBLE) each time the slot type of the RO for the retransmission of the preamble message changes. In other examples, the UE may maintain two separate power states that carry the current PREAMBLE_RECEIVED_TARGET_POWER for both SBFD and HD slot types, and the UE transmits the retransmission of the preamble message with the power of the state that matches the slot type for the retransmission. In other examples, the UE may add an offset to transmissions and/or retransmissions of preamble messages in SBFD slots. The offset may further be applicable to each of the foregoing examples.

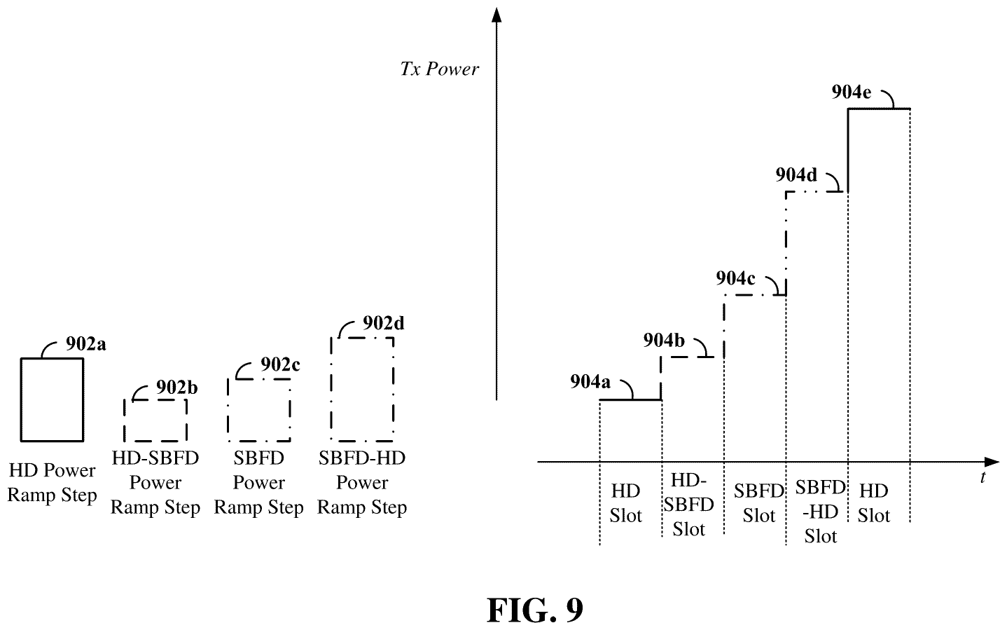

FIG. 9 is a diagram illustrating an example of power control for RACH preamble retransmissions based on slot types according to some aspects. In the example shown in FIG. 9, four separate power ramping steps are defined. A first power ramping step 902a (HD Power Ramp Step) is defined for preamble transmissions in half-duplex (HD) slots (e.g., the initial preamble transmission or both the last transmission and the new retransmission occur in a RO of a HD slot). For example, if preamble transmission x and preamble transmission x+1 both occur in a HD slot, the UE may use the power ramping value PREAMBLE_POWER_RAMPING_STEP.

A second power ramping step 902b (HD-SBFD Power Ramp Step) is defined for preamble retransmissions at a transition between a HD slot and a SBFD slot (e.g., the last preamble transmission is in a RO of a HD slot and the new retransmission is in a RO of a SBFD slot). For example, if preamble transmission x occurs in a HD slot and preamble transmission x+1 occurs in a SBFD slot, the UE may use the power ramping value PREAMBLE_POWER_RAMPING_STEP_HD_FD.

A third power ramping step 902c (SBFD Power Ramp Step) is defined for preamble retransmissions in SBFD slots (e.g. the initial preamble transmission or both the last transmission and the new retransmission occur in a RO of a SBFD slot). For example, if preamble transmission x and preamble transmission x+1 both occur in a SBFD slot, the UE may use the power ramping value PREAMBLE_POWER_RAMPING_STEP_FD.

A fourth power ramping step 902d (SBFD-HD Power Ramp Step) is defined for preamble retransmissions at a transition between a SBFD slot and a HD slot (e.g., the last preamble transmission is in a RO of a SBFD slot and the new retransmission is in a RO of a HD slot). For example, if preamble transmission x occurs in a SBFD slot and preamble transmission x+1 occurs in a HD slot, the UE may use the power ramping value PREAMBLE_POWER_RAMPING_STEP_FD_HD.

Thus, the power ramping step depends on the slot type of the previous PRACH transmission/retransmission and the slot type of current PRACH retransmission. As shown in the example of FIG. 9, an initial preamble message transmission 904a occurs in a HD slot, and as a result, the HD Power Ramp Step 902a (e.g., PREAMBLE_POWER_RAMPING_STEP) (e.g., with counter set to 1) is applied to the initial transmission 904a. Thereafter, a first retransmission 904b occurs in a HD slot, and as a result, the HD-SBFD Power Ramp Step 902b (e.g., PREAMBLE_POWER_RAMPING_STEP_HD_FD) is applied to the first retransmission 904b. A second retransmission 904c then occurs in a SBFD slot, and therefore, the SBFD Power Ramp Step 902c (e.g., PREAMBLE_POWER_RAMPING_STEP_FD) is applied to the second retransmission 904c. A third retransmission 904d occurs in a HD slot, and therefore, the SBFD-HD Power Ramp Step 902d (e.g., PREAMBLE_POWER_RAMPING_STEP_FD_HD) is applied to the third retransmission 904d. Finally, a fourth retransmission 904e occurs in a HD slot, and therefore, the HD Power Ramp Step 902a (e.g., PREAMBLE_POWER_RAMPING_STEP) is applied to the fourth retransmission 904e.

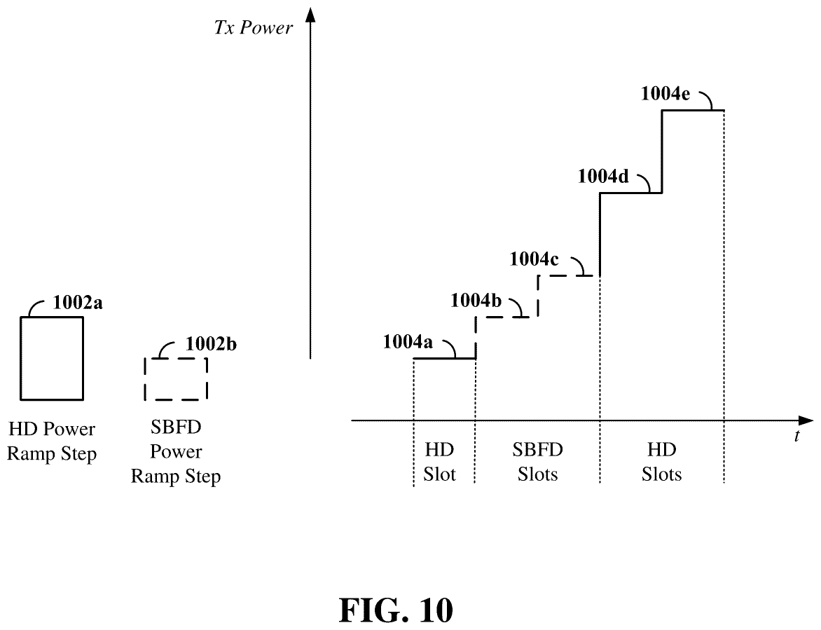

FIG. 10 is a diagram illustrating another example of power control for RACH preamble retransmissions based on slot type according to some aspects. In the example shown in FIG. 10, two separate power ramping steps are defined. A first power ramping step 1002a (HD Power Ramp Step) is defined for preamble transmissions in half-duplex (HD) slots. For example, if preamble transmission x and preamble transmission x+1 both occur in a HD slot, the UE may use the power ramping value PREAMBLE_POWER_RAMPING_STEP. In addition, if preamble transmission x occurs in a SBFD slot and preamble transmission x+1 occurs in a HD slot, the UE may also use the power ramping value PREAMBLE_POWER_RAMPING_STEP.

A second power ramping step 1002b (SBFD Power Ramp Step) is defined for preamble transmissions in SBFD slots. For example, if preamble transmission x and preamble transmission x+1 both occur in a SBFD slot, the UE may use the power ramping value PREAMBLE_POWER_RAMPING_STEP_FD. In addition, if preamble transmission x occurs in a HD slot and preamble transmission x+1 occurs in a SBFD slot, the UE may also use the power ramping value PREAMBLE_POWER_RAMPING_STEP_FD.

Thus, the power ramping step depends on the slot type of the current PRACH retransmission. As shown in the example of FIG. 10, an initial preamble message transmission 1004a occurs in a HD slot, and as a result, the HD Power Ramp Step 1002a (e.g., PREAMBLE_POWER_RAMPING_STEP) (e.g., with counter set to 1) is applied to the initial transmission 1004a. Thereafter, the first and second retransmissions 1004b and 1004c each occur in a SBFD slot, and as a result, the SBFD Power Ramp Step 1002b (e.g., PREAMBLE_POWER_RAMPING_STEP_FD) is applied to the first retransmission 1004b and the second retransmission 1004c. Third and fourth retransmissions 1004d and 1004e then occur in HD slots, and therefore, the HD Power Ramp Step 1002a (e.g., PREAMBLE_POWER_RAMPING_STEP) is applied to the third retransmission 1004d and the fourth retransmission 1004e.

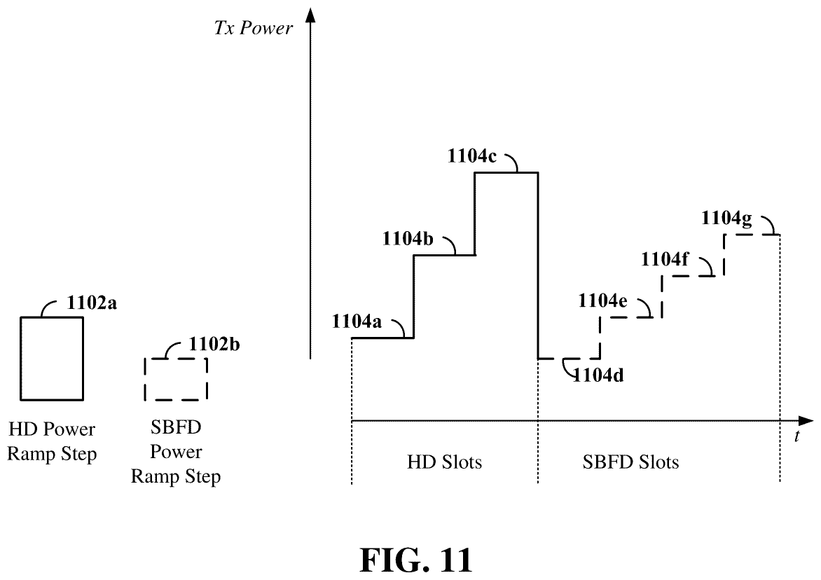

FIG. 11 is a diagram illustrating another example of power control for RACH preamble retransmissions based on slot type according to some aspects. In the example shown in FIG. 11, two separate power ramping steps are defined. A first power ramping step 1102a (HD Power Ramp Step) is defined for preamble transmissions in half-duplex (HD) slots. For example, if preamble transmission x and preamble transmission x+1 both occur in a HD slot, the UE may use the power ramping value PREAMBLE_POWER_RAMPING_STEP.

A second power ramping step 1102b (SBFD Power Ramp Step) is defined for preamble transmissions in SBFD slots. For example, if preamble transmission x and preamble transmission x+1 both occur in a SBFD slot, the UE may use the power ramping value PREAMBLE_POWER_RAMPING_STEP_FD.

However, if the slot type changes between the previous (last) preamble retransmission and the current preamble retransmission, the UE resets the transmission power to the initial transmission power. For example, if preamble transmission x occurs in a HD slot and preamble transmission x+1 occurs in a SBFD slot, the UE may reset the transmission power to preambleReceivedTargetPower+DELTA_PREAMBLE.

The UE may reset the PREAMBLE_Power_Rampin_Counter when UE the slot type of the RACH occasions changes between SBFD to non-SBFD or vice versa. Similarly, if preamble transmission x occurs in a SBFD slot and preamble transmission x+1 occurs in a HD slot, the UE may reset the transmission power to preambleReceivedTargetPower+DELTA_PREAMBLE. In some examples, the reambleReceivedTargetPower and/or the DELTA_PREAMBLE may be different for SBFD slots and HD slots (e.g., preambleReceivedTargetPower+DELTA_PREAMBLE and preambleReceivedTargetPower+DELTA_PREAMBLE_FD).

Thus, the transmission power depends on the slot type of the previous PRACH transmission and the current PRACH retransmission. As shown in the example of FIG. 11, an initial preamble message transmission 1104a is sent in an HD slot at an initial transmission power of preambleReceivedTargetPower+DELTA_PREAMBLE. In addition, each of a first retransmission 1104b and a second retransmission 1104c occur in a HD slot, and as a result, the HD Power Ramp Step 1102a (e.g., PREAMBLE_POWER_RAMPING_STEP) is applied to the first retransmission 1104b and the second retransmission 1104c. Thereafter, a third retransmission 1104d occurs in a SBFD slot, and as a result, the UE resets the transmission power to preambleReceivedTargetPower+DELTA_PREAMBLE_FD. Subsequent retransmissions 1104e, 1104f, and 1104g each occur in a SBFD slot, and as a result, the SBFD Power Ramp Step 1102b (e.g., PREAMBLE_POWER_RAMPING_STEP_FD) is applied to the subsequent retransmissions 1104d, 1104e, and 1104f.

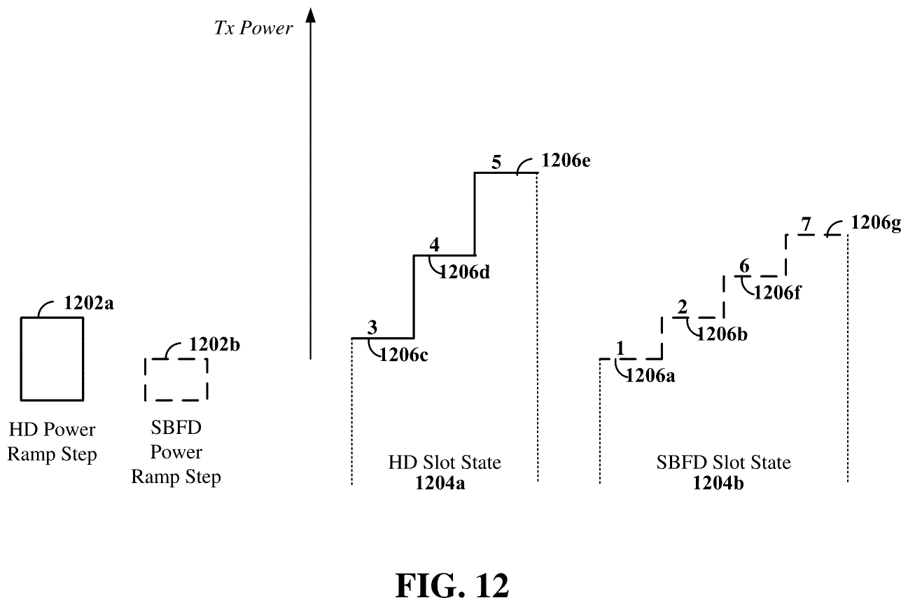

FIG. 12 is a diagram illustrating another example of power control for RACH preamble retransmissions based on slot type according to some aspects. In the example shown in FIG. 12, two separate power ramping steps are defined. A first power ramping step 1202a (HD Power Ramp Step) is defined for preamble transmissions in half-duplex (HD) slots. In addition, a second power ramping step 1202b (SBFD Power Ramp Step) is defined for preamble transmissions in SBFD slots.

In the example shown in FIG. 12, the UE maintains two power states (loops) 1204a and 1204b that determine the value of the PREAMBLE_RECEIVED_TARGET_POWER. For example, an index 1 that can have a value of 0 (e.g., for HD) or 1 (e.g., for SBFD) may index the PREAMBLE_RECEIVED_TARGET_POWER(l) such that:

$${P}_{PRACH , b , f , c} ( i ) = min \{ {P}_{CMAX , f , c} ( i , l ) , {P}_{PRACH , target , f , c} ( l ) + {PL}_{b , f , c} \} \qquad ( Equation 3 )$$

where each of the slot types has a separate configured maximum power P_{CMAX,f,c}(i,l). In addition, the PRACH target power may be separately configured as:

$${P}_{PRACH , target , f , c} ( l ) = preambleReceivedTargetPower ( l ) + DELTA\_PREAMBLE ( l ) + ( PREAMBLE\_POWER \_RAMPING \_COUNTER ( l ) - 1 ) \times PREAMBLE\_POWER \_RAMPING \_STEP ( l ) + POWER\_OFFSET \_ 2 STEP\_RA . \qquad ( Equation 4 )$$

Thus, each slot type may have a separate configured initial target power (preambleReceivedTargetPower(l)+DELTA_PREAMBLE(l)), a separate counter (PREAMBLE_POWER_RAMPING_COUNTER(l)) and separate power ramping steps (PREAMBLE_POWER_RAMPING_STEP(l)).

Thus, transmission power depends on the power state of the slot type of the current preamble retransmission. As shown in the example of FIG. 12, the UE transmits an initial RACH preamble message 1206a in a SBFD slot at an initial transmission power (preambleReceivedTargetPower_FD+DELTA_PREAMBLE_FD) for SBFD slots, as indicated in the SBFD slot state 1204b. A first retransmission 1206b occurs in a SBFD slot, and therefore, the UE applies the SBFD Power Ramp Step 1202b to the transmit power for transmission of the first retransmission 1206b. For example, the UE may determine the preamble transmission power as:

$$PREAMBLE\_RECEIVED \_TARGET \_POWER ( l = 1 ) = preambleReceivedTargetPower\_FD + DELTA\_PREAMBLE \_FD + ( PREAMBLE\_POWER \_RAMPING \_COUNTER \_FD ) - 1 ) \times PREAMBLE\_POWER \_RAMPING \_STEP \_FD + POWER\_OFFSET \_ 2 STEP\_RA \qquad ( Equation 5 )$$

The UE further maintains the SBFD power state 1204b with the preamble transmission power of the first retransmission 1206b.

A second retransmission 1206c occurs in a HD slot, and therefore, the UE transmits the second retransmission 1206c in a HD slot at an initial transmission power (preambleReceivedTargetPower+DELTA_PREAMBLE) for HD slots, as indicated in the HD slot state 1204a. Each of a third retransmission 1206d and a fourth retransmission 1206e also occur in a HD slot, and therefore, the UE applies the HD Power Ramp Step 1202a to the transmit power for transmission of the third and fourth retransmissions 1206d and 1206e. For example, the UE may determine the preamble transmission power as:

$$PREAMBLE\_RECEIVED \_TARGET \_POWER ( l = 0 ) = preambleReceivedTargetPower + DELTA\_PREAMBLE + ( PREAMBLE\_POWER \_RAMPING \_COUNTER ) - 1 ) \times PREAMBLE\_POWER \_RAMPING \_STEP + POWER\_OFFSET \_ 2 STEP\_RA \qquad ( Equation 6 )$$

The UE further maintains the HD power state 1204a with the preamble transmission power of the latest (fourth) retransmission 1206e. A fifth retransmission 1206f occurs in a SBFD slot, and therefore, the UE accesses the SBFD power state 1204b to determine the last transmission power for a preamble retransmission in a SBFD slot. The UE then applies the SBFD Power Ramp Step 1202b to the transmit power for transmission of the fifth retransmission 1206e, as described above. In addition, a sixth retransmission 1206f also occurs in a SBFD slot, and therefore, the UE applies the SBFD Power Ramp Step 1202b to the transmit power for transmission of the sixth retransmission 1206f based on the current SBFD power state 1204b, as described above.

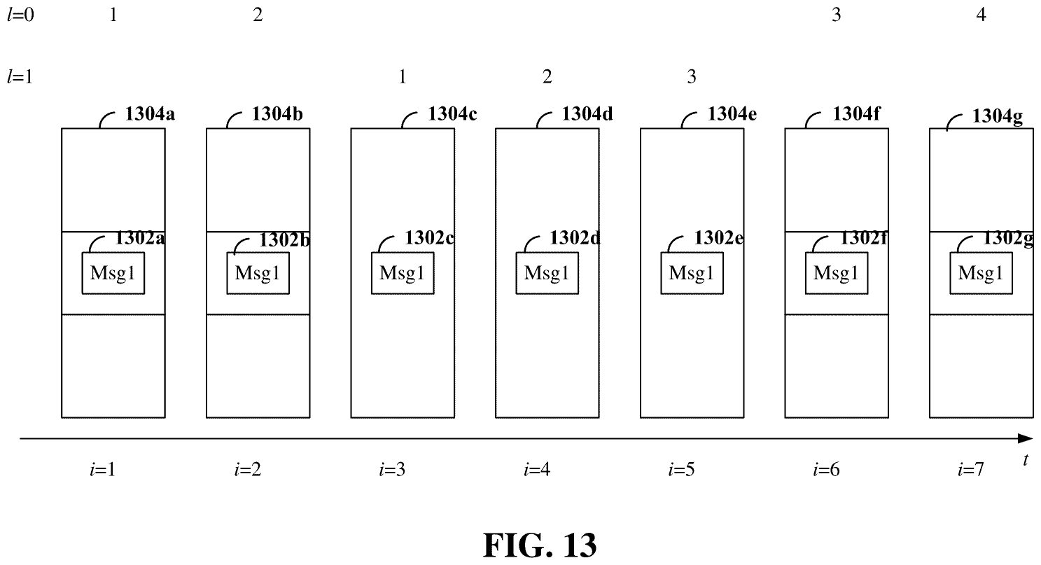

FIG. 13 is a diagram illustrating an example of RACH preamble retransmissions based on slot type power states according to some aspects. In the example shown in FIG. 13, an initial preamble transmission (e.g., Msg1) 1302a (i=1) is transmitted in a SBFD slot 1304a. Thus, the counter for the power state for SBFD (1=0) is initialized at one (e.g., PREAMBLE_POWER_RAMPING_COUNTER_FD is set to one). A first preamble retransmission 1302b (i=2) is then transmitted in SBFD slot 1304b, and the counter for the power state for SBFD (1=0) is incremented by one (e.g., PREAMBLE_POWER_RAMPING_COUNTER_FD=2). A second preamble retransmission 1302c (i=3) is then transmitted in HD slot 1304c, and the counter for the power state for HD (l=1) is initialized at one (e.g., PREAMBLE_POWER_RAMPING_COUNTER is set to one). A third preamble retransmission 1302d (i=4) is then transmitted in HD slot 1304d, and the counter for the power state for HD (l=1) is incremented by one (e.g., PREAMBLE_POWER_RAMPING_COUNTER=2). A fourth preamble retransmission 1302e (i=5) is then transmitted in HD slot 1304e, and the counter for the power state for HD (l=1) is incremented by one (e.g., PREAMBLE_POWER_RAMPING_COUNTER=3). A fifth preamble retransmission 1302f (i=6) is then transmitted in SBFD slot 1304f, and the counter for the power state for SBFD (l=0) is incremented by one (e.g., PREAMBLE_POWER_RAMPING_COUNTER_FD=3). A sixth retransmission 1302g (i=7) is then transmitted in SBFD slot 1304f, and the counter for the power state for SBFD (l=0) is incremented by one (e.g., PREAMBLE_POWER_RAMPING_COUNTER_FD=4).

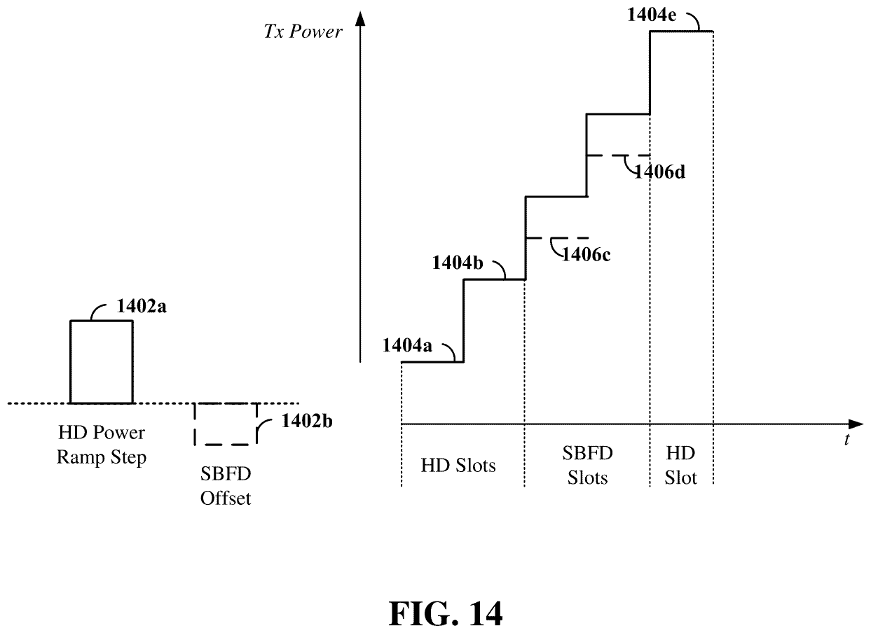

FIG. 14 is a diagram illustrating another example of power control for RACH preamble retransmissions based on slot type according to some aspects. In the example shown in FIG. 14, a power ramping step 1402a is defined for half-duplex slots (HD Power Ramp Step). In addition, a power ramping offset 1402b is defined for SBFD slots. The offset 1402b is applied to each RACH preamble retransmission that occurs in a SBFD slot. The offset 1402b may be applied in addition to any other SBFD power ramping step that may be defined for SBFD slots. For example, the offset 1402b may be used in conjunction with the examples shown in FIGS. 9-13.

As shown in the example of FIG. 14, an initial RACH preamble transmission 1404a occurs in a HD slot. Therefore, the HD Power Ramp Step 1402a (e.g., PREAMBLE_POWER_RAMPING_STEP) (e.g., with counter set to 1) is applied to the initial transmission 1404a. Thereafter, a first retransmission 1404b is transmitted within another HD slot, and therefore, the HD Power Ramp Step 1402a (e.g., PREAMBLE_POWER_RAMPING_STEP) (e.g., with counter set to 2) is applied to the first retransmission 1404b. A third retransmission 1404c then occurs within a SBFD slot. Therefore, the HD Power Ramp Step 1402a (e.g., PREAMBLE_POWER_RAMPING_STEP) (e.g., with counter set to 3) and the SBFD offset 1402b are both applied to the third retransmission 1404c. Similarly, a fourth retransmission 1404d is also transmitted within a SBFD slot, and therefore, both the HD Power Ramp Step 1402a (e.g., PREAMBLE_POWER_RAMPING_STEP) (e.g., with counter set to 4) and the SBFD offset 1402b are applied to the fourth retransmission 1404d. A fifth retransmission 1404e occurs within a HD slot, and therefore, the HD Power Ramp Step 1402a (e.g., PREAMBLE_POWER_RAMPING_STEP) (e.g., with counter set to 5) is applied to the fifth retransmission 1404e (e.g., no SBFD power offset is applied to the fifth retransmission).

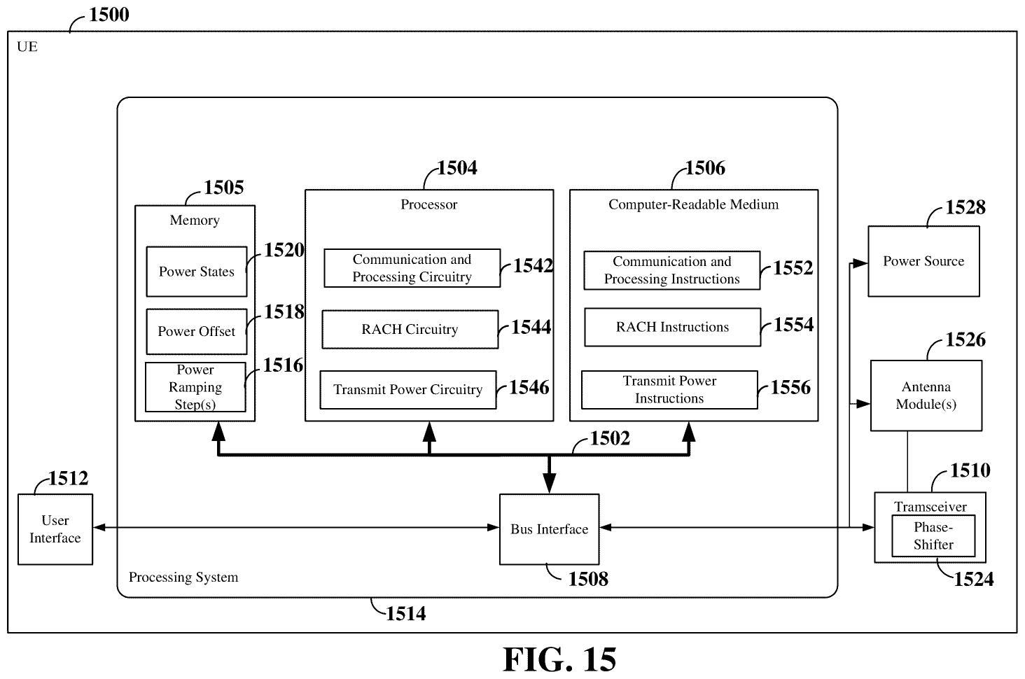

FIG. 15 is a block diagram illustrating an example of a hardware implementation of a user equipment (UE) 1500 employing a processing system 1514 according to some aspects. For example, the UE 1500 may correspond to any of the UEs shown and described above in reference to FIGS. 1, 3, 6 and/or 7.

In accordance with various aspects of the disclosure, an element, or any portion of an element, or any combination of elements may be implemented with a processing system 1514 that includes one or more processors, such as processor 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1500 may be configured to perform any one or more of the functions described herein. That is, the processor 1504, as utilized in the UE 1500, may be used to implement any one or more of the methods or processes described herein.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits, including one or more processors (represented generally by the processor 1504), one or more memories (represented generally by the memory 1505), and one or more computer-readable media (represented generally by the computer-readable medium 1506). In some examples, the computer-readable media 1506 may be included within or part of one or more of the memories 1505. The bus 1502 may also link various other circuits such as timing sources, peripherals, voltage regulators, and power management circuits, which are well known in the art, and therefore, are not described any further.

A bus interface 1508 provides an interface between the bus 1502, one or more transceivers 1510, and one or more antenna modules (e.g., one or more antenna arrays or panels) 1526. The transceiver 1510 and antenna module(s) 1526 provides a means for communicating with various other apparatus over a transmission medium (e.g., air interface). The bus interface 1508 further provides an interface between the bus 1502 and a power source 1528 (e.g., a battery). The bus interface 1508 further provides an interface between the bus 1502 and a user interface 1512 (e.g., keypad, display, touch screen, speaker, microphone, control features, etc.). Of course, such a user interface 1512 may be omitted in some examples.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system. In some examples, the computer-readable medium 1506 may be implemented on an article of manufacture, which may further include one or more other elements or circuits, such as the processor 1504 and/or memory 1505.

The computer-readable medium 1506 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1504, may be responsible for managing the bus 1502 and general processing, including the execution of the software (e.g., instructions or computer-executable code) stored on the computer-readable medium 1506. The software, when executed by the processor 1504, causes the processing system 1514 to perform the various processes and functions described herein for any particular apparatus. The computer-readable medium 1506 and/or the memory 1505 may also be used for storing data that may be manipulated by the processor 1504 when executing software. For example, the memory 1505 may store one or more of configured grant (CG) information 1516, UTO indication(s) 1518, and/or a reclaim indication 1520.

In some aspects of the disclosure, the processor 1504 may include circuitry configured for various functions. For example, the processor 1504 may include communication and processing circuitry 1542 configured to communicate with one or more UEs and/or one or more network entities. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1542 may include one or more transmit/receive chains.

In some implementations where the communication involves receiving information, the communication and processing circuitry 1542 may obtain information from a component of the UE 1500 (e.g., from the transceiver 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the transceiver 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

In some examples, the communication and processing circuitry 1542 may be configured to receive and process downlink beamformed signals at a mmWave frequency or a sub-6 GHz frequency via the transceiver 1510 and the antenna module(s) 1526 (e.g., using aphase-shifter 1524). In addition, the communication and processing circuitry 1542 may be configured to generate and transmit uplink beamformed signals at a mmWave frequency or a sub-6 GHz frequency via the transceiver 1510 and antenna module(s) 1526 (e.g., using the phase-shifter 1524).

In some examples, the communication and processing circuitry 1542 may be configured to transmit via the transceiver 1510 a first random access preamble message in a first slot to a network entity, such as a gNB, or other aggregated or disaggregated base station. The communication and processing circuitry 1542 may further be configured to transmit a second random access preamble message in a second slot. Each of the first slot and the second slot may have a respective slot type associated therewith. For example, the respective slot type may be a half-duplex slot type or a sub-band full-duplex (SBFD) slot type. The communication and processing circuitry 1542 may further be configured to execute communication and processing software 1552 stored on the computer-readable medium 1506 to implement one or more functions described herein.

The processor 1504 may further include RACH circuitry 1544, configured to generate the first random access preamble message and the second random access preamble message. For example, the RACH circuitry 1544 may be configured to randomly select a preamble from an available set of preambles within the cell served by the network entity for each of the first preamble message and the second preamble message. The RACH circuitry 1544 may further be configured to select a respective random access (RACH) occasion (RO) for each of the first preamble message and the second preamble message. In some examples, the respective slot type of each of the first slot and the second slot is based on a respective random access occasion (RO) configuration for each of the first slot and the second slot. The respective RO configuration being one of a first RO configuration associated with half-duplex slots or a second RO configuration associated with at least SBFD slots. The RACH circuitry 1544 may further be configured to execute RACH instructions (software) 1554 stored on the computer-readable medium 1506 to implement one or more functions described herein.

The processor 1504 may further include transmit power circuitry 1546, configured to control the respective transmit power of the first random access preamble message and the second random access preamble message. For example, the transmit power circuitry 1546 may be configured to set a first transmit power (e.g., using the power source 1528) for the first random access preamble message and a second transmit power (e.g., using the power source 1528) for the second random access preamble message.

The transmit power circuitry 1546 may further be configured to increment the first transmit power by a power ramping step to produce the second transmit power based on the respective slot type of at least the second slot. In some examples, the power ramping step includes a first power ramping step in response to the first slot being a half-duplex slot type and the second slot being a SBFD slot type and a second power ramping step different than the first power ramping step in response to the first slot being the SBFD slot type and the second slot being the half-duplex slot type. In some examples, the power ramping step includes a first power ramping step in response to the second slot being the SBFD slot type and a second power ramping step different than the first power ramping step in response to the second slot being the half-duplex slot type.

The transmit power circuitry 1546 may further be configured to provide a first power ramping step for the half-duplex slot type and a second power ramping step for the SBFD slot type. In some examples, the transmit power circuitry 1546 may be configured to increment the first transmit power by the first power ramping step to produce the second transmit power in response to each of the first slot and the second slot being the half-duplex slot type. In some examples, the transmit power circuitry 1546 may be configured to increment the first transmit power by the second power ramping step to produce the second transmit power in response to each of the first slot and the second slot being the SBFD slot type. In some examples, the transmit power circuitry 1546 may be configured to reset the first transmit power to an initial transmit power to produce the second transmit power in response to the first slot being the SBFD slot type and the second slot being the half-duplex slot type or the first slot being the half-duplex slot type and the second slot being the SBFD slot type. Here, the initial transmit power may be specified by a higher layer parameter (e.g., RRC parameter). In this example, the initial transmit power may correspond to the slot type of the second slot.

In some examples, the transmit power circuitry 1546 may be configured to maintain a first power state for the half-duplex slot type and a second power state for the SBFD slot type. The first power state may include a last half-duplex transmit power of a last half-duplex random access preamble message transmission in the half-duplex slot type and the second power state may include a last SBFD transmit power of a last SBFD random access preamble message transmission in the SBFD slot type. In this example, the transmit power circuitry 1546 may further be configured to increment the last half-duplex transmit power by the first power ramping step to produce the second transmit power in response to the second slot comprising the half-duplex slot type and to increment the last SBFD transmit power by the second power ramping step to produce the second transmit power in response to the second slot comprising the SBFD slot type.

The transmit power circuitry 1546 may further be configured to increment the first transmit power by a power ramping step to produce the second transmit power based on the slot type of the second slot being the half-duplex slot type and to increment the first transmit power by the power ramping step plus an offset to produce the second transmit power based on the slot type of the second slot being the SBFD slot type. The transmit power circuitry 1546 may further be configured to execute transmit power instructions (software) 1556 stored on the computer-readable medium 1506 to implement one or more functions described herein.

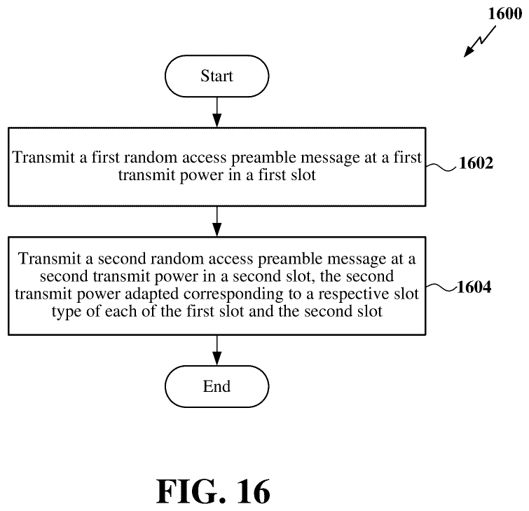

FIG. 16 is a flow chart illustrating an exemplary process 1600 for PRACH power control in SBFD networks according to some aspects. As described below, some or all illustrated features may be omitted in a particular implementation within the scope of the present disclosure, and some illustrated features may not be required for implementation of all embodiments. In some examples, the process 1600 may be carried out by the UE 1500 illustrated in FIG. 15. In some examples, the process 1600 may be carried out by any suitable apparatus or means for carrying out the functions or algorithm described below.

At block 1602, the UE may transmit a first random access preamble message at a first transmit power in a first slot. For example, the communication and processing circuitry 1542, in combination with the RACH circuitry 1544, transmit power circuitry 1546, and transceiver 1510, shown and described above in connection with FIG. 15 may provide a means to transmit the first random access preamble message.

At block 1604, the UE may transmit a second random access preamble message at a second transmit power in a second slot. The second transmit power is adapted corresponding to a respective slot type of each of the first slot and the second slot, where the respective slot type is a half-duplex slot type or a sub-band full-duplex (SBFD) slot type. For example, the communication and processing circuitry 1542, in combination with the RACH circuitry 1544, transmit power circuitry 1546 and transceiver 1510, shown and described above in connection with FIG. 15 may provide a means to transmit the second random access preamble message.

In some examples, the UE may increment the first transmit power by a power ramping step to produce the second transmit power based on the respective slot type of at least the second slot. In some examples, the power ramping step includes a first power ramping step in response to the first slot being a half-duplex slot type and the second slot being a SBFD slot type and a second power ramping step different than the first power ramping step in response to the first slot being the SBFD slot type and the second slot being the half-duplex slot type. In some examples, the power ramping step includes a first power ramping step in response to the second slot being the SBFD slot type and a second power ramping step different than the first power ramping step in response to the second slot being the half-duplex slot type.

In some examples, the UE may further provide a first power ramping step for the half-duplex slot type and a second power ramping step for the SBFD slot type. In some examples, the UE may increment the first transmit power by the first power ramping step to produce the second transmit power in response to each of the first slot and the second slot being the half-duplex slot type. In some examples, the UE may increment the first transmit power by the second power ramping step to produce the second transmit power in response to each of the first slot and the second slot being the SBFD slot type. In some examples, the UE may reset the first transmit power to an initial transmit power to produce the second transmit power in response to the first slot being the SBFD slot type and the second slot being the half-duplex slot type or the first slot being the half-duplex slot type and the second slot being the SBFD slot type. Here, the initial transmit power may be specified by a higher layer parameter (e.g., RRC parameter). In this example, the initial transmit power may correspond to the slot type of the second slot.

In some examples, the UE may maintain a first power state for the half-duplex slot type and a second power state for the SBFD slot type. The first power state may include a last half-duplex transmit power of a last half-duplex random access preamble message transmission in the half-duplex slot type and the second power state may include a last SBFD transmit power of a last SBFD random access preamble message transmission in the SBFD slot type. In this example, the UE may increment the last half-duplex transmit power by the first power ramping step to produce the second transmit power in response to the second slot comprising the half-duplex slot type and to increment the last SBFD transmit power by the second power ramping step to produce the second transmit power in response to the second slot comprising the SBFD slot type.

In some examples, the UE may further increment the first transmit power by a power ramping step to produce the second transmit power based on the slot type of the second slot being the half-duplex slot type and to increment the first transmit power by the power ramping step plus an offset to produce the second transmit power based on the slot type of the second slot being the SBFD slot type.

In one configuration, the UE includes means for transmitting a first random access preamble message at a first transmit power in a first slot, and means for transmitting a second random access preamble message at a second transmit power in a second slot, wherein the second transmit power is adapted corresponding to a respective slot type of each of the first slot and the second slot, wherein the respective slot type comprises a half-duplex slot type or a sub-band full-duplex (SBFD) slot type. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 3, 6, 7, and/or 15, and utilizing, for example, the processes and/or algorithms described herein in relation to FIG. 16.

The following provides an overview of aspects of the present disclosure:

Aspect 1: A method operable at a user equipment (UE), the method comprising: transmitting a first random access preamble message at a first transmit power in a first slot; and transmitting a second random access preamble message at a second transmit power in a second slot, wherein the second transmit power is adapted corresponding to a respective slot type of each of the first slot and the second slot, wherein the respective slot type comprises a half-duplex slot type or a sub-band full-duplex (SBFD) slot type.

Aspect 2: The method of aspect 1, further comprising: incrementing the first transmit power by a power ramping step to produce the second transmit power based on the respective slot type of at least the second slot.

Aspect 3: The method of aspect 2, wherein the power ramping step comprises: a first power ramping step in response to the first slot comprising the half-duplex slot type and the second slot comprising the SBFD slot type, and a second power ramping step different than the first power ramping step in response to the first slot comprising the SBFD slot type and the second slot comprising the half-duplex slot type.

Aspect 4: The method of aspect 2: wherein the power ramping step comprises: a first power ramping step in response to the second slot comprising the SBFD slot type, and a second power ramping step different than the first power ramping step in response to the second slot comprising the half-duplex slot type.

Aspect 5: The method of aspect 1, further comprising: providing a first power ramping step for the half-duplex slot type and a second power ramping step for the SBFD slot type.

Aspect 6: The method of aspect 5, further comprising: incrementing the first transmit power by the first power ramping step to produce the second transmit power in response to each of the first slot and the second slot comprising the half-duplex slot type.

Aspect 7: The method of aspect 5, further comprising: incrementing the first transmit power by the second power ramping step to produce the second transmit power in response to each of the first slot and the second slot comprising the SBFD slot type.

Aspect 8: The method of aspect 5, further comprising: resetting the first transmit power to an initial transmit power to produce the second transmit power in response to the first slot comprising the SBFD slot type and the second slot comprising the half-duplex slot type or the first slot comprising the half-duplex slot type and the second slot comprising the SBFD slot type, wherein the initial transmit power is specified by a higher layer parameter.

Aspect 9: The method of aspect 8, wherein the initial transmit power corresponds to the slot type of the second slot.

Aspect 10: The method of aspect 5, further comprising: maintaining a first power state for the half-duplex slot type and a second power state for the SBFD slot type, wherein the first power state comprises a last half-duplex transmit power of a last half-duplex random access preamble message transmission in the half-duplex slot type and the second power state comprises a last SBFD transmit power of a last SBFD random access preamble message transmission in the SBFD slot type.

Aspect 11: The method of aspect 10, further comprising: incrementing the last half-duplex transmit power by the first power ramping step to produce the second transmit power in response to the second slot comprising the half-duplex slot type; and incrementing the last SBFD transmit power by the second power ramping step to produce the second transmit power in response to the second slot comprising the SBFD slot type.

Aspect 12: The method of any of aspects 1 through 11, further comprising: incrementing the first transmit power by a power ramping step to produce the second transmit power based on the slot type of the second slot comprising the half-duplex slot type; and incrementing the first transmit power by the power ramping step plus an offset to produce the second transmit power based on the slot type of the second slot comprising the SBFD slot type.

Aspect 13: The method of any of aspects 1 through 12, wherein the respective slot type of each of the first slot and the second slot is based on a respective random access occasion (RO) configuration for each of the first slot and the second slot, the respective RO configuration being one of a first RO configuration associated with half-duplex slots or a second RO configuration associated with at least SBFD slots.

Aspect 14: The method of any of aspects 1 through 13, wherein the SBFD slot type comprises an in-band full-duplex (IBFD) slot type.

Aspect 15: An apparatus configured for wireless communication at a user equipment (UE) comprising one or more memories and one or more processors coupled to the one or more memories, the one or more processors configured to perform a method of any of aspects 1 through 14.

Aspect 16: An apparatus configured for wireless communication at a user equipment (UE) comprising means for performing a method of any of aspects 1 through 14.

Aspect 17: A non-transitory computer-readable medium having stored therein instructions executable by one or more processors of a user equipment (UE) to perform a method of any one of aspects 1 through 14.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 6, 7, and/or 15 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus for wireless communication at a user equipment (UE), the apparatus comprising:
one or more memories; and
one or more processors coupled to the one or more memories, the one or more processors being configured to:
transmit a first random access preamble message at a first transmit power in a first slot; and
transmit a second random access preamble message at a second transmit power in a second slot, wherein the second transmit power is adapted corresponding to a respective slot type of each of the first slot and the second slot, wherein the respective slot type comprises a half-duplex slot type or a sub-band full-duplex (SBFD) slot type.

2. The apparatus of claim 1, wherein the one or more processors are further configured to:
increment the first transmit power by a power ramping step to produce the second transmit power based on the respective slot type of at least the second slot.

3. The apparatus of claim 2, wherein the power ramping step comprises:
a first power ramping step in response to the first slot comprising the half-duplex slot type and the second slot comprising the SBFD slot type; and
a second power ramping step different than the first power ramping step in response to the first slot comprising the SBFD slot type and the second slot comprising the half-duplex slot type.

4. The apparatus of claim 2, wherein the power ramping step comprises:
a first power ramping step in response to the second slot comprising the SBFD slot type; and
a second power ramping step different than the first power ramping step in response to the second slot comprising the half-duplex slot type.

5. The apparatus of claim 1, wherein the one or more processors are further configured to:
provide a first power ramping step for the half-duplex slot type and a second power ramping step for the SBFD slot type.

6. The apparatus of claim 5, wherein the one or more processors are further configured to:
increment the first transmit power by the first power ramping step to produce the second transmit power in response to each of the first slot and the second slot comprising the half-duplex slot type.

7. The apparatus of claim 5, wherein the one or more processors are further configured to:
increment the first transmit power by the second power ramping step to produce the second transmit power in response to each of the first slot and the second slot comprising the SBFD slot type.

8. The apparatus of claim 5, wherein the one or more processors are further configured to:
reset the first transmit power to an initial transmit power to produce the second transmit power in response to the first slot comprising the SBFD slot type and the second slot comprising the half-duplex slot type or the first slot comprising the half-duplex slot type and the second slot comprising the SBFD slot type, wherein the initial transmit power is specified by a higher layer parameter.

9. The apparatus of claim 8, wherein the initial transmit power corresponds to the slot type of the second slot.

10. The apparatus of claim 5, wherein the one or more processors are further configured to:
maintain a first power state for the half-duplex slot type and a second power state for the SBFD slot type, wherein the first power state comprises a last half-duplex transmit power of a last half-duplex random access preamble message transmission in the half-duplex slot type and the second power state comprises a last SBFD transmit power of a last SBFD random access preamble message transmission in the SBFD slot type.

11. The apparatus of claim 10, wherein the one or more processors are further configured to:
increment the last half-duplex transmit power by the first power ramping step to produce the second transmit power in response to the second slot comprising the half-duplex slot type; and
increment the last SBFD transmit power by the second power ramping step to produce the second transmit power in response to the second slot comprising the SBFD slot type.

12. The apparatus of claim 1, wherein the one or more processors are further configured to:
increment the first transmit power by a power ramping step to produce the second transmit power based on the slot type of the second slot comprising the half-duplex slot type; and
increment the first transmit power by the power ramping step plus an offset to produce the second transmit power based on the slot type of the second slot comprising the SBFD slot type.

13. The apparatus of claim 1, wherein the respective slot type of each of the first slot and the second slot is based on a respective random access occasion (RO) configuration for each of the first slot and the second slot, the respective RO configuration being one of a first RO configuration associated with half-duplex slots or a second RO configuration associated with at least SBFD slots.

14. The apparatus of claim 1, wherein the SBFD slot type comprises an in-band full-duplex (IBFD) slot type.

15. A method operable at a user equipment (UE), the method comprising:
transmitting a first random access preamble message at a first transmit power in a first slot; and
transmitting a second random access preamble message at a second transmit power in a second slot, wherein the second transmit power is adapted corresponding to a respective slot type of each of the first slot and the second slot, wherein the respective slot type comprises a half-duplex slot type or a sub-band full-duplex (SBFD) slot type.

16. The method of claim 15, further comprising:
incrementing the first transmit power by a power ramping step to produce the second transmit power based on the respective slot type of at least the second slot, wherein the power ramping step comprises:
a first power ramping step in response to the first slot comprising the half-duplex slot type and the second slot comprising the SBFD slot type; and
a second power ramping step different than the first power ramping step in response to the first slot comprising the SBFD slot type and the second slot comprising the half-duplex slot type.

17. The method of claim 15, further comprising:
incrementing the first transmit power by a power ramping step to produce the second transmit power based on the respective slot type of at least the second slot, wherein the power ramping step comprises:
a first power ramping step in response to the second slot comprising the SBFD slot type; and
a second power ramping step different than the first power ramping step in response to the second slot comprising the half-duplex slot type.

18. The method of claim 15, further comprising:
providing a first power ramping step for the half-duplex slot type and a second power ramping step for the SBFD slot type;
incrementing the first transmit power by the first power ramping step to produce the second transmit power in response to each of the first slot and the second slot comprising the half-duplex slot type; and
incrementing the first transmit power by the second power ramping step to produce the second transmit power in response to each of the first slot and the second slot comprising the SBFD slot type.

19. The method of claim 15, further comprising:
providing a first power ramping step for the half-duplex slot type and a second power ramping step for the SBFD slot type; and
resetting the first transmit power to an initial transmit power to produce the second transmit power in response to the first slot comprising the SBFD slot type and the second slot comprising the half-duplex slot type or the first slot comprising the half-duplex slot type and the second slot comprising the SBFD slot type, wherein the initial transmit power is specified by a higher layer parameter.

20. The method of claim 15, further comprising:
providing a first power ramping step for the half-duplex slot type and a second power ramping step for the SBFD slot type;
maintaining a first power state for the half-duplex slot type and a second power state for the SBFD slot type, wherein the first power state comprises a last half-duplex transmit power of a last half-duplex random access preamble message transmission in the half-duplex slot type and the second power state comprises a last SBFD transmit power of a last SBFD random access preamble message transmission in the SBFD slot type;
incrementing the last half-duplex transmit power by the first power ramping step to produce the second transmit power in response to the second slot comprising the half-duplex slot type; and
incrementing the last SBFD transmit power by the second power ramping step to produce the second transmit power in response to the second slot comprising the SBFD slot type.
